(19) United States
(12) Patent Application Publication
(10) Pub. No.: US 2024/0121190 A1
(43) Pub. Date: Apr. 11, 2024

(54) DESIGN DEVICE, DESIGN METHOD, AND DESIGN PROGRAM

(71) Applicant: Nippon Telegraph and Telephone Corporation, Tokyo (JP)

(72) Inventors: Shohei KAMAMURA, Musashino-shi, Tokyo (JP); Yuhei HAYASHI, Musashino-shi, Tokyo (JP); Yuki MIYOSHI, Musashino-shi, Tokyo (JP); Takeaki NISHIOKA, Musashino-shi, Tokyo (JP); Chiharu MORIOKA, Musashino-shi, Tokyo (JP); Satoshi NAKATSUKASA, Musashino-shi, Tokyo (JP); Yuki TAKEI, Musashino-shi, Tokyo (JP)

(21) Appl. No.: 18/276,953

(22) PCT Filed: Feb. 12, 2021
(86) PCT No.: PCT/JP2021/005371

§ 371 Date: Aug. 11, 2023

(51) Int. Cl. H04L 47/12

(52) U.S. Cl. CPC H04L 47/12

(57) ABSTRACT

A design apparatus optimizes, with a first granularity (for example, a real number solution), a traffic volume allocated to each of links between adjacent nodes included in a network. In addition, the design apparatus calculates an approximation solution obtained by approximating, with a second granularity (for example, an integer solution), the traffic volume having been optimized with the first granularity. Furthermore, the design apparatus maps logical paths to each of routes constituted by the links in accordance with the approximated traffic volume.

### TECHNICAL FIELD

The present invention relates to a design apparatus, a design method, and a design program.

### BACKGROUND ART

In order to efficiently accommodate traffic while satisfying various policies related to reliability and quality specific to carriers, a network operator needs to appropriately design a route for accommodating traffic.

In order to efficiently accommodate traffic, conventionally, due to restrictions on network apparatus implementation, a route between certain endpoint nodes is generally formed on a same single route regardless of accommodated users or services or randomly distributed to a plurality of routes.

On the other hand, in recent years, there have been developed a technique for monitoring details of traffic to identify users and services to be accommodated and a technique for setting logical paths in units of subdivided traffic, and by utilizing these techniques, further improvement in traffic accommodation efficiency is expected.

As a route calculation method when a traffic demand and a network topology are given, there is known a method of calculating, based on a link cost assigned to each link of the topology, a route which minimizes a sum of the link costs using the Dijkstra method or the like.

For example, NPL 1 proposes a method of minimizing a maximum link utilization rate and improving traffic accommodation efficiency in a network by creatively providing link costs.

In addition, there is an approach using a mathematical programming problem as a method of calculating an exact optimal solution when a traffic demand and a network topology are given.

For example, NPL 2 defines two problems, namely, a bifurcation program for calculating a real number solution allowing traffic branching and merging between start and end point nodes (a branching-allowed problem, hereinafter referred to as a BP) and a non-bifurcation program for calculating an integer solution serving as a single route between start and end point nodes (a non-branching problem, hereinafter referred to as an NBP).

### CITATION LIST

### Non Patent Literature

[NPL 1] B. Fortz, M. Thorup, “Internet Traffic Engineering by Optimizing OSPF Weights,” in IEEE INFOCOM 2000.
[NPL 2] Y. Wang and Z. Wang, “Explicit Routing Algorithms for Internet Traffic Engineering,” in Proc. of ICCCN '99, September 1999.

### SUMMARY OF INVENTION

### Technical Problem

However, the prior art has a problem that it is difficult to design a route having high traffic accommodation efficiency in a communication network by a realistic method.

For example, in the heuristic solution described in NPL 1, a route is indirectly obtained with a minimum sum of link costs and an exact optimal solution may not be obtained.

In addition, for example, since a BP described in NPL 2 can be formulated as a linear programming problem and an NBP can be formulated as an integer programming problem, rigorous optimization can be calculated.

On the other hand, while a calculation in a BP is performed at high speed since a real number solution is calculated, the calculated real number solution is not a solution that can be set in an existing NW (network) apparatus. Furthermore, while an NBP is an integer solution and therefore can be set in an existing NW apparatus, since the problem is NP-hard, calculation on a carrier network scale cannot be executed within a practical time.

### Solution to Problem

In order to solve the problem described above and to achieve an object, a design apparatus includes: an optimizing unit which optimizes, with a first granularity, a traffic volume allocated to each of links between adjacent nodes included in a network; and an approximation calculating unit which calculates an approximation solution obtained by approximating, with a second granularity, the traffic volume having been optimized with the first granularity.

### Advantageous Effects of Invention

According to the present invention, a route with high traffic accommodation efficiency in a communication network can be designed by a realistic method.

### BRIEF DESCRIPTION OF DRAWINGS

FIG. 1 is a diagram illustrating a BP and an NBP.

FIG. 2 is a diagram showing a configuration example of a communication system according to a first embodiment.

FIG. 3 is a diagram showing a configuration example of a design apparatus according to the first embodiment.

FIG. 4 is a diagram illustrating a flow of a route calculation.

FIG. 5 is a diagram illustrating a traffic matrix.

FIG. 6 is a diagram showing an example of a traffic matrix.

FIG. 7 is a flowchart showing a flow of processing of the design apparatus according to the first embodiment.

FIG. 8 is a flowchart showing a flow of mapping processing.

FIG. 9 is a diagram showing an example of mapping processing.

FIG. 10 is a diagram illustrating a Suval method.

FIG. 11 is a diagram showing an example of a computer that executes a design program.

### DESCRIPTION OF EMBODIMENTS

Hereinafter, embodiments of a design apparatus, a design method, and a design program according to the present application will be described in detail with reference to the drawings. Note that the present invention is not limited by the embodiments described below.

### [BP and NBP]

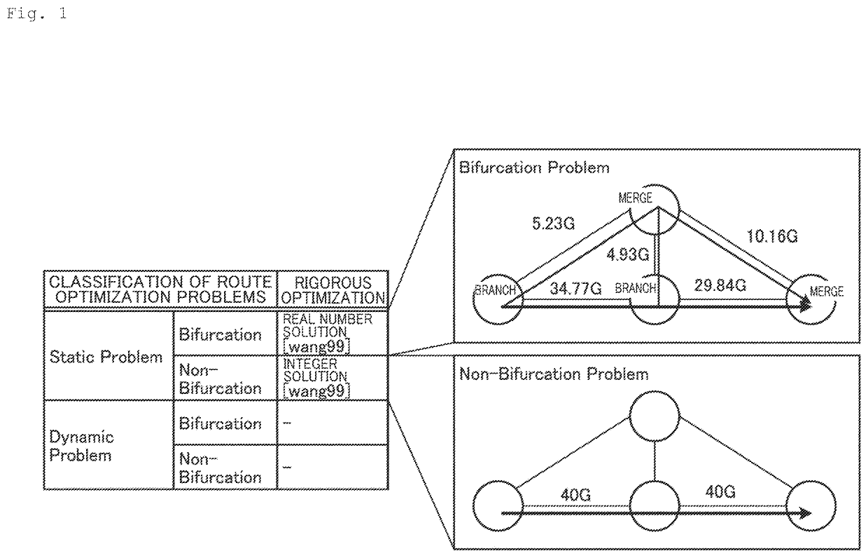

FIG. 1 is a diagram illustrating a BP and an NBP. As shown in FIG. 1, rigorous optimization in a BP and an NBP is performed by, for example, wang99.

In a BP, midway branching of traffic is allowed. As described earlier, since a BP provides a real number solution, a calculation can be readily (quickly) performed but the solution is not suitable for implementation. In addition, although an NBP provides an integer solution and therefore can be implemented, the problem is NP-hard and a calculation is not practical.

On the other hand, assuming a carrier network scale, although the approach by BP is effective, since an existing NW apparatus is unable to perform branching and merging of traffic and set logical paths at a granularity of an arbitrary real number, a result of an optimization calculation using a BP cannot be applied.

An object of the present embodiment is to realize a design method that solves the problems of a BP and an NBP.

### First Embodiment

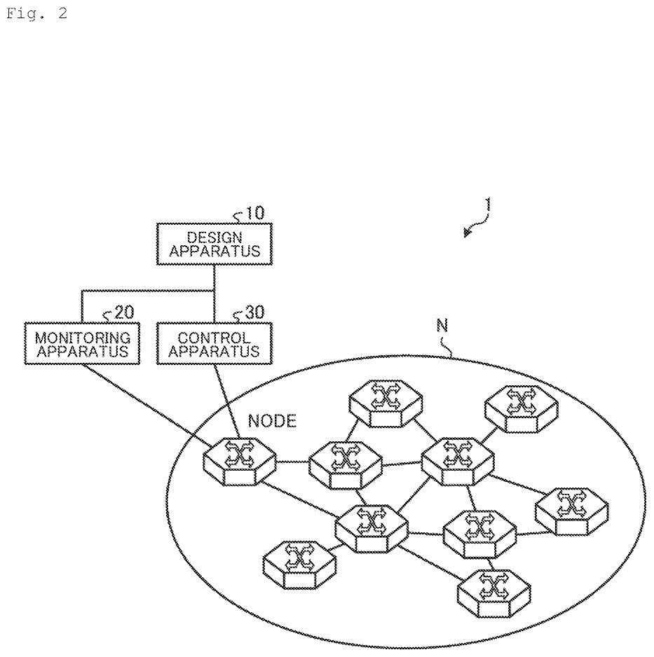

FIG. 2 is a diagram showing a configuration example of a communication system according to a first embodiment. As shown in FIG. 1, a communication system 1 includes a communication network N, a design apparatus 10, a monitoring apparatus 20, and a control apparatus 30.

The communication network N is a packet network including a plurality of nodes. For example, the nodes are an IP router, an L2 switch, and the like. In addition, the nodes of the communication network N are connected by a link such as an optical fiber.

The design apparatus 10 performs route design of the communication network N. For example, the design apparatus 10 manages a network configuration based on information from the monitoring apparatus 20 and the control apparatus 30 and designs (calculates) a route.

The monitoring apparatus 20 monitors the communication network N. For example, the monitoring apparatus 20 observes a traffic volume flowing through each link and a traffic matrix information for each logical path (such as a VPN) set by a start point node and an end point node. In addition, the monitoring apparatus 20 provides the design apparatus 10 and the control apparatus 30 with the obtained traffic information.

The control apparatus 30 controls the communication network N. For example, the control apparatus 30 sets route information designed by the design apparatus 10 to each node.

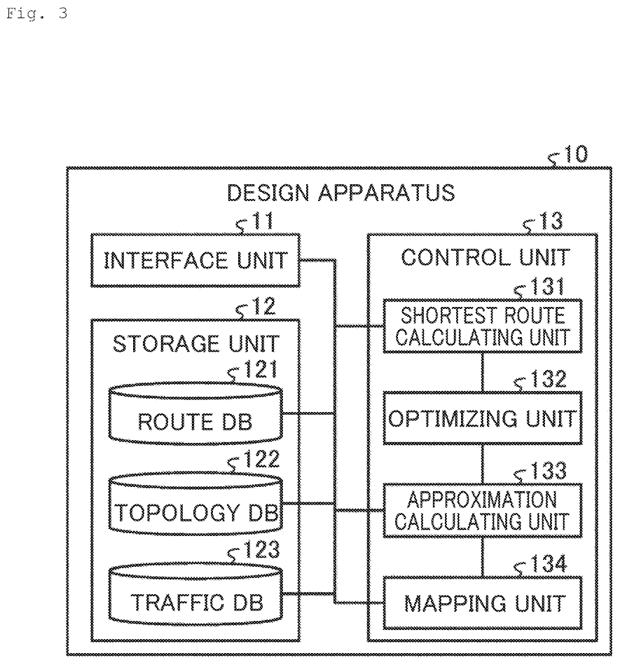

FIG. 3 is a diagram showing a configuration example of the design apparatus according to the first embodiment. The design apparatus 10 receives input of information observed by the monitoring apparatus 20. For example, the design apparatus 10 receives input of a topology and a traffic matrix of the communication network N. In addition, the design apparatus 10 outputs route information to the control apparatus 30.

As shown in FIG. 3, the design apparatus 10 includes an interface unit 11, a storage unit 12, and a control unit 13.

The interface unit 11 is an interface for inputting and outputting data. For example, the interface unit 11 is an NIC (Network Interface Card). The interface unit 11 is capable of transmitting and receiving data to and from other apparatuses.

In addition, the interface unit 11 may be connected to an input apparatus such as a mouse or a keyboard. Furthermore, the interface unit 11 may be connected to an output apparatus such as a display and a speaker. Accordingly, the interface unit 11 functions as an interface with a network operator.

The storage unit 12 is a storage apparatus such as an HDD (Hard Disk Drive), an SSD (Solid State Drive), or an optical disk. Note that the storage unit 12 may be a data-rewritable semiconductor memory such as a RAM (Random Access Memory), a flash memory, or an NVSRAM (Non Volatile Static Random Access Memory). The storage unit 12 stores an OS (Operating System) and various types of programs to be executed by the design apparatus 10.

The storage unit 12 stores a route DB 121, a topology DB 122, and a traffic DB 123.

The route DB 121 holds route information for each logical path set between a start point node and an end point node. A method of calculating route information will be described later.

The topology DB 122 holds connection information of nodes and links and capacity information of each link. In addition, the traffic DB 123 manages traffic information for each link and traffic matrix information for each logical path.

The design apparatus 10 calculates route information from the topology DB 122 and the traffic DB 123 and stores the calculated route information in the route DB 121. In addition, the design apparatus 10 may output the calculated route information.

The control unit 13 controls the entire design apparatus 10. For example, the control unit 13 is an electronic circuit such as a CPU (Central Processing Unit), a MPU (Micro Processing Unit), or a GPU (Graphics Processing Unit), or an integrated circuit such as an ASIC (Application Specific Integrated Circuit) or an FPGA (Field Programmable Gate Array). In addition, the control unit 13 has an internal memory for storing programs and control data defining various types of processing procedures and executes each processing step using the internal memory.

The control unit 13 functions as various processing units due to the operation of various programs. For example, the control unit 13 includes a shortest route calculating unit 131, an optimizing unit 132, an approximation calculating unit 133, and a mapping unit 134.

The shortest route calculating unit 131 calculates a shortest route between a designated start point node and a designated end point node.

The optimizing unit 132 optimizes, with a first granularity, a traffic volume allocated to each of links between adjacent nodes included in the network. For example, the optimizing unit 132 optimizes a traffic matrix volume with a real number solution. For example, the first granularity is a real number.

The approximation calculating unit 133 calculates an approximation solution obtained by approximating, with a second granularity, the traffic volume having been optimized with the first granularity. For example, the approximation calculating unit 133 approximates a real number solution with an integer solution. For example, the second granularity is an integer.

The mapping unit 134 maps a logical path to each of the routes constituted by a link according to the traffic volume approximated by the approximation calculating unit 133.

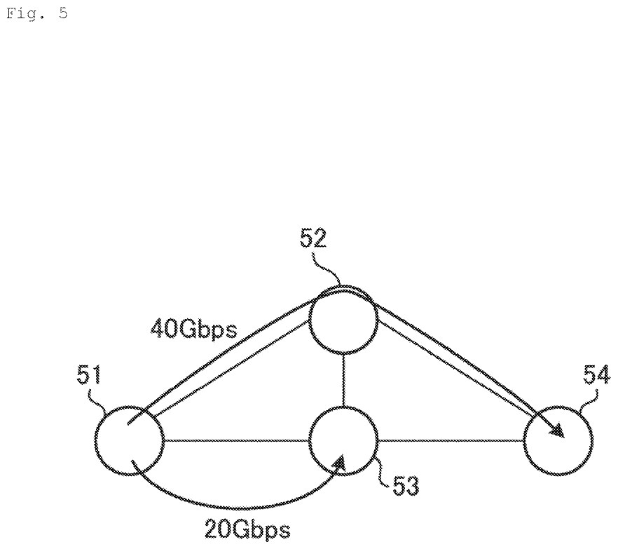

A traffic matrix will now be described with reference to FIG. 5. FIG. 5 is a diagram illustrating a traffic matrix.

A traffic matrix represents a traffic volume of a route (set of links) between a start point node and an end point node instead of a total traffic volume flowing through a link between adjacent nodes.

In the example shown in FIG. 5, the traffic matrix between nodes 51 and 54 is 40 Gbps. In addition, the traffic matrix between nodes 51 and 52 is 20 Gbps.

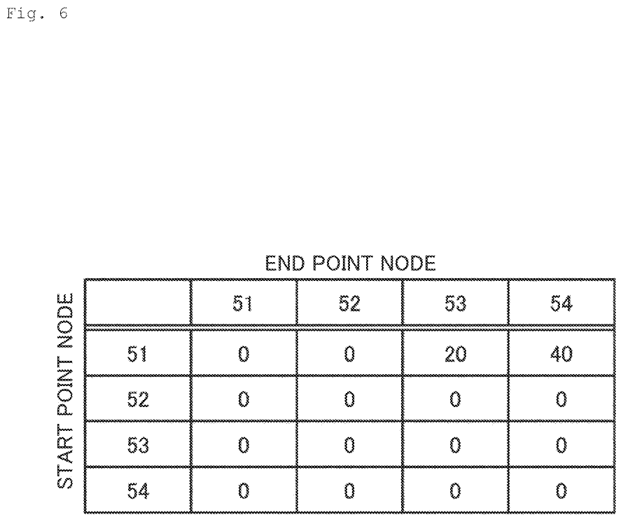

FIG. 6 is a diagram showing an example of a traffic matrix. When two traffic matrices are generated as shown in FIG. 5, a matrix notation is used as shown in a table in FIG. 6.

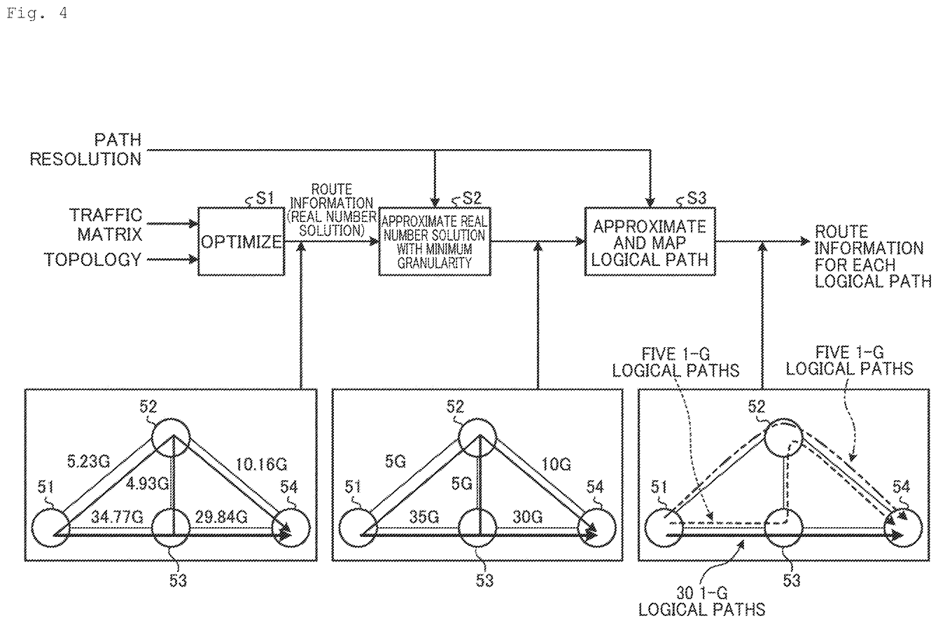

Route calculation by the design apparatus 10 will be described in more detail with reference to FIG. 4. FIG. 4 is a diagram illustrating a flow of route calculation.

As shown in FIG. 4, the design apparatus 10 is given a path resolution, a traffic matrix, and a topology. The path resolution refers to a minimum granularity (for example, an integer) of a traffic volume which can be set to a route.

For example, a unit of a traffic volume which can be set to a route may be determined. This unit corresponds to a minimum granularity. For example, if the allocatable unit is 1 G (bps) as shown in FIG. 4, the minimum granularity is an integer.

In step S1 in FIG. 4, the optimizing unit 132 calculates an optimal route to be a real number solution from the traffic matrix and the topology. For example, the optimizing unit 132 calculates a real number solution by the method described in NPL 2.

In the example shown in FIG. 4, the optimizing unit 132 calculates a traffic volume of the link between the nodes 51 and 53 by a real number as 34.77 G. In addition, the optimizing unit 132 calculates the traffic volume of the link between the nodes 53 and 54 as 29.84 G.

In this case, since the solution calculated by the linear programming method described in NPL 2 is a real number solution, the solution is to have a granularity which cannot be set by the given path resolution.

In consideration thereof, in step S2, the approximation calculating unit 133 approximates the solution calculated by the optimizing unit 132 with a value to be a multiple of the path resolution or, in other words, the minimum granularity. For example, the approximation calculating unit 133 performs rounding off or truncation of digits lower than the path resolution (in this case, the first decimal place or lower).

In the example shown in FIG. 4, the approximation calculating unit 133 approximates the traffic volume of the link between the node 51 and the node 53 from 34.77 G to 35 G. In addition, the approximation calculating unit 133 approximates the traffic volume of the link between the node 53 and the node 54 from 29.84 G to 30 G.

Furthermore, in step S3, the mapping unit 134 maps traffic to each route. At this point, the mapping unit 134 performs mapping so that the traffic volume allocated to each link becomes as close as possible to the calculation result of the approximation calculating unit 133.

In the example shown in FIG. 4, the mapping unit 134 maps 30 logical paths of 1 G to a route between the nodes 51 and 54 via the node 53.

Note that design processing (various calculations and mapping) by the design apparatus 10 according to the present embodiment may be performed not only when a route of the communication network N is initially designed but also when the traffic matrix fluctuates.

When the traffic matrix fluctuates, the design apparatus 10 can calculate the traffic volume once again and calculate a total difference from a state prior to the occurrence of the fluctuation of the traffic matrix. In addition, the design apparatus 10 may calculate a route between designated locations and obtain a solution with respect to a traffic fluctuation during network operation by obtaining a difference only between the designated locations.

### [Processing According to First Embodiment]

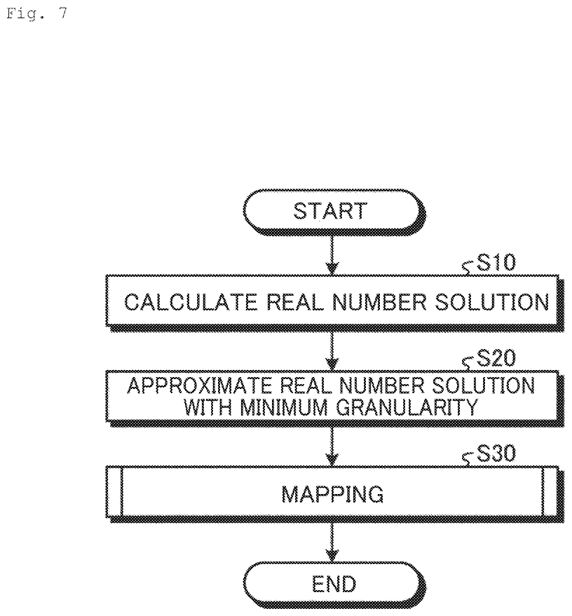

FIG. 7 is a flowchart showing a flow of processing by the design apparatus according to the first embodiment. As shown in FIG. 7, the design apparatus 10 calculates a real number solution of a traffic volume of each link (step S10).

Next, the design apparatus 10 approximates the real number solution with a minimum granularity (for example, an integer) (step S20). Subsequently, the design apparatus 10 performs mapping of a logical path to each route based on the approximated integer solution (step S30).

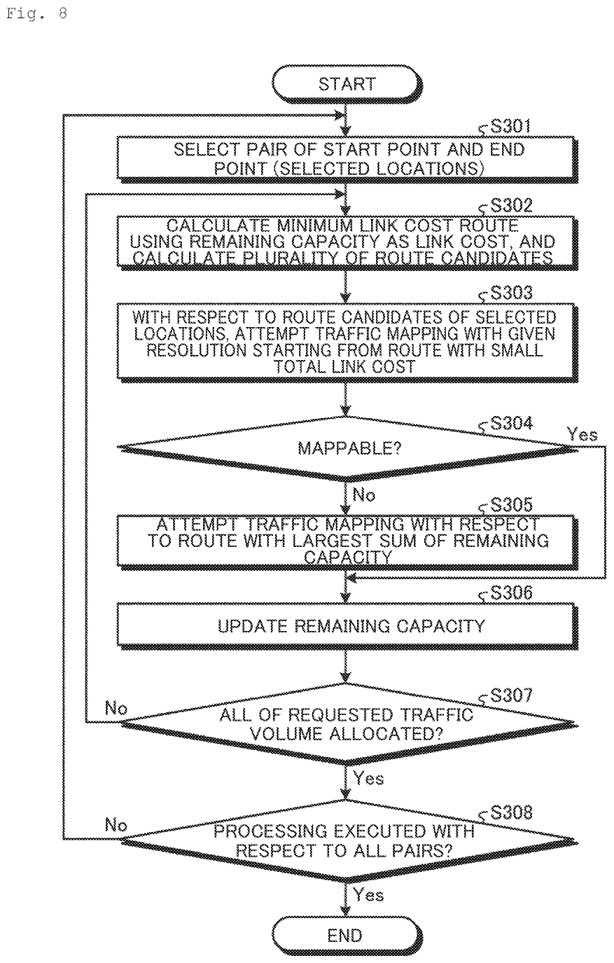

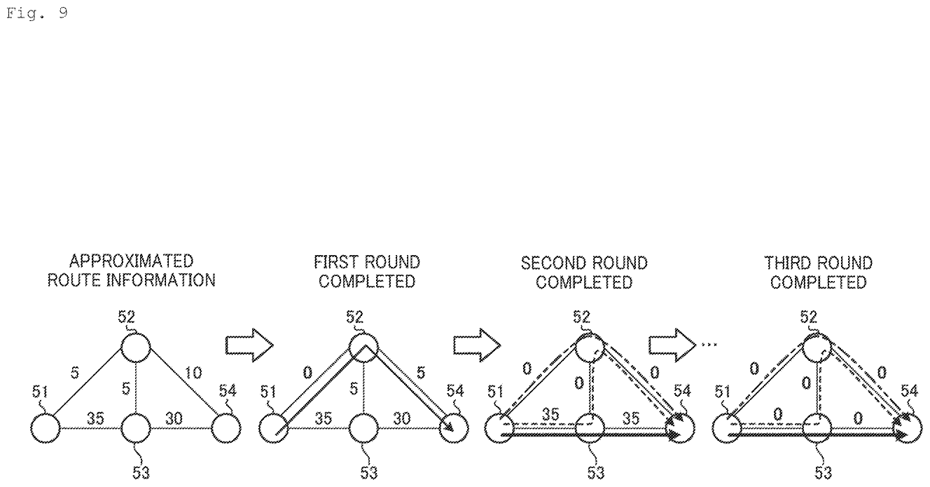

FIG. 8 is a flowchart showing the flow of mapping processing. The processing shown in FIG. 8 corresponds to the processing of step S30 in FIG. 7. In addition, the steps shown in FIG. 7 and the example shown in FIG. 9 will be described in association with each other as appropriate. FIG. 9 is a diagram showing an example of mapping processing.

First, the mapping unit 134 selects a pair of a start point node and an end point node (selected locations) (step S301). In the example shown in FIG. 9, the mapping unit 134 selects the node 51 in the approximated route information as the start point node and selects the node 54 in the approximated route information as the end point node. At this point, the selected locations are the node 51 and the node 54.

In this case, although a real number solution is calculated for all pairs of a start point node and an end point node, since the real number solution is calculated for each pair, the mapping unit 134 may select pairs in any kind of order.

Next, the shortest route calculating unit 131 calculates a minimum link cost route by using a remaining capacity (approximated traffic volume) as a link cost and calculates a plurality of route candidates (step S302). In the example shown in FIG. 9, the shortest route calculating unit 131 calculates the following route candidates.

First route candidate: Node 51→node 52→node 54 (total link cost: 5+10=15)

Second route candidate: Node 51→node 53→node 52→node 54 (total link cost: 35+5+10=50)

Third route candidate: Node 51→node 52→node 53→node 54 (total link cost: 5+5+30=40)

Fourth route candidate: Node 51→node 53→node 54 (total link cost: 35+30=65)

The shortest route calculating unit 131 can calculate a plurality of route candidates using a method of calculating k-number of routes by executing the Dijkstra method and deleting a link used once, a method of calculating k-number of routes having overlapping link use by using a K-shortest path algorithm, a method of calculating K-number of disjointed routes using the Suval method, and the like.

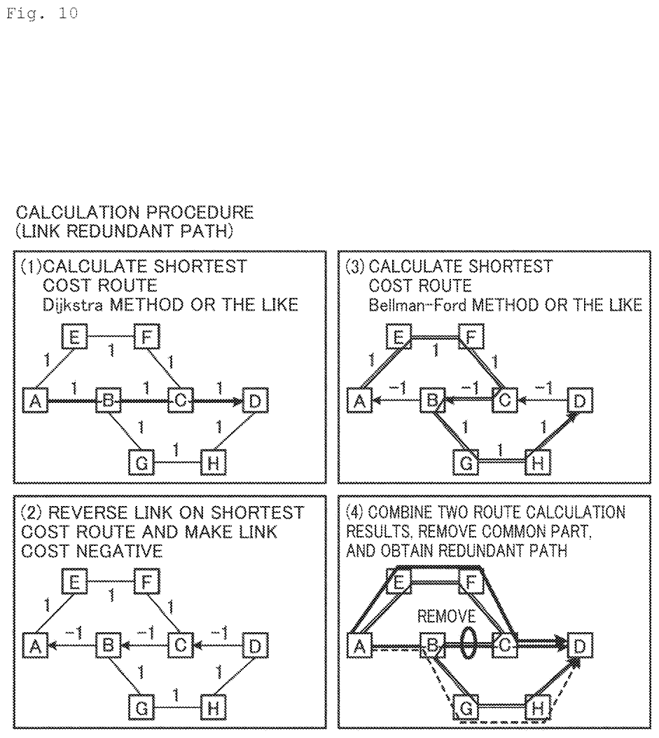

FIG. 10 is a diagram illustrating the Suval method. As shown in FIG. 10, the Suval method is performed according to the following procedure.

(1) Calculate a shortest cost route using the Dijkstra method or the like.

(2) Reverse a link on the shortest cost route and make the link cost negative.

(3) Calculate a shortest cost route using the Bellman-Ford method or the like.

(4) Combine the two route calculation results, remove a common part, and obtain a redundant path.

The Suval method is a node/link redundant path calculation algorithm. According to the Suval method, when a node/link redundant path exists, the path can be found without fail. In the Suval method, a set which minimizes a sum of the costs of an active path and a standby path is found. On the other hand, even if a node/link redundant path exists, the method of applying the Dijkstra method (shortest route search algorithm) twice may fail to find the path.

The mapping unit 134 attempts to map traffic with a given resolution starting from a route candidate of selected locations with a small total link cost (step S303). In the example shown in FIG. 9, the mapping unit 134 attempts mapping to a first route candidate with a minimum total link cost in a first round.

When the mapping is completed (step S304, yes), the mapping unit 134 advances to step S306. In addition, the mapping unit 134 updates the remaining capacity (step S306). In the example shown in FIG. 9, the mapping unit 134 updates the remaining capacity of each link of the first route candidate in the first round.

The link cost of a link of which the remaining capacity is updated to 0 is considered to be a sufficiently large value (for example, infinity) in next and subsequent rounds.

When mapping has not been successful for any route candidate (step S304, no), the mapping unit 134 advances to step S305. In addition, the mapping unit 134 attempts traffic mapping with respect to a route having a largest sum of remaining capacity (step S305).

At this point, when the mapping unit 134 has allocated all of the requested traffic volume (the volume of traffic matrix generated at the selected locations) (step S307, yes), the mapping unit 134 advances to step S308. On the other hand, when the mapping unit 134 has not allocated all of the requested traffic volume (step S307, no), the mapping unit 134 returns to step S302 and repeats the processing.

In addition, when the mapping unit 134 has executed processing with respect to all pairs (step S308, yes), the mapping unit 134 terminates the processing. On the other hand, when the mapping unit 134 has not executed processing with respect to all pairs (step S308, no), the mapping unit 134 returns to step S301 and repeats the processing.

In this manner, the mapping unit 134 prioritizes mapping to a route of which the approximated traffic volume is small, and when the approximated traffic volume is not sufficient, performs mapping by prioritizing a route of which the approximated traffic volume is largest.

In the example shown in FIG. 9, traffic is mapped in order from a route having a small remaining capacity, and since a link cost is treated as a large value when the remaining capacity becomes zero or less, traffic mapping is performed to a route having a remaining capacity.

Since the traffic volume to be mapped is uniform according to the resolution, a method of allocating the traffic volume starting from a route having a small residual capacity and a method of conversely allocating the traffic volume starting from a traffic volume having a large residual capacity only differ from each other in a capacity at a mapping destination and, conceivably, there is no difference in performance.

### [Effects of the First Embodiment]

As described above, the optimizing unit 132 optimizes the traffic volume allocated to each of the links between adjacent nodes included in the network with a first granularity. The approximation calculating unit 133 calculates an approximation solution obtained by approximating, with a second granularity, the traffic volume having been optimized with the first granularity.

As described earlier, prior art has a problem of impracticality in that a real number solution cannot be actually set to a network or calculations cannot be performed on a carrier network scale. In the present embodiment, a solution that can be actually set is calculated while approximating an optimum solution. As a result, according to the present embodiment, it is possible to design a route with high traffic accommodation efficiency in a communication network by a realistic method. Furthermore, designing a route with high traffic accommodation efficiency produces an effect of reducing facility cost.

In addition, the optimizing unit 132 optimizes a traffic matrix volume with a real number solution. The approximation calculating unit 133 approximates the real number solution with an integer solution. Accordingly, logical paths can be mapped in 1 Gbps units.

Furthermore, the mapping unit 134 maps a logical path to each of routes constituted by links according to the traffic volume approximated by the approximation calculating unit 133. Accordingly, the design apparatus 10 can reflect the result of the approximation calculation on an actual communication network.

In addition, the mapping unit 134 prioritizes mapping to a route of which the approximated traffic volume is small, and when the approximated traffic volume is not sufficient, performs mapping by prioritizing a route of which the approximated traffic volume is largest. Accordingly, the design apparatus 10 can realize efficient mapping.

### [System Configuration and the Like]

It is to be understood that each illustrated component of each apparatus is functionally conceptual and it is not required that each component of each apparatus be physically constructed as illustrated. In other words, specific modes of distribution and/or integration of each apparatus are not limited to the illustrated modes and all or a part thereof can be functionally or physically distributed and/or integrated in arbitrary units in accordance with various loads, usage, or the like. Furthermore, all of or a part of each processing function that is carried out by each apparatus may be realized by a CPU and a program that is analyzed and executed by the CPU or may be realized as hardware based on wired logic. The program may be executed not only by a CPU but also by another processor such as a GPU.

In addition, among processing steps described in the present embodiment, all of or a part of processing steps described as being automatically performed may be performed manually, or all of or a part of processing steps described as being manually performed may be performed automatically using known methods. Furthermore, information including processing procedures, control procedures, specific names, and various types of data and parameters set forth in the description given above and in the drawings can be arbitrarily changed unless otherwise specified.

### [Program]

As an embodiment, the design apparatus 10 can be implemented by installing a design program that performs the design processing described above in a desired computer as package software or online software. For example, by causing an information processing apparatus to execute the design program described above, the information processing apparatus can be caused to function as the design apparatus 10. An information processing apparatus as used herein includes desktop and laptop personal computers. Furthermore, information processing apparatuses also include a mobile communication terminal such as a smart phone, a mobile phone, or a PHS (Personal Handyphone System), a slate terminal such as a PDA (Personal Digital Assistant), and the like.

In addition, with a terminal apparatus used by a user being a client, the design apparatus 10 may be implemented as a design server apparatus which provides the client with a service related to the design processing described above. For example, the design server apparatus is implemented as a server apparatus providing a design service which receives a traffic matrix and a topology of a communication network as input and which provides a mapping result of a logical path as output. In this case, the design server apparatus may be implemented as a Web server or may be implemented as a cloud for providing a service related to the design processing described above through outsourcing.

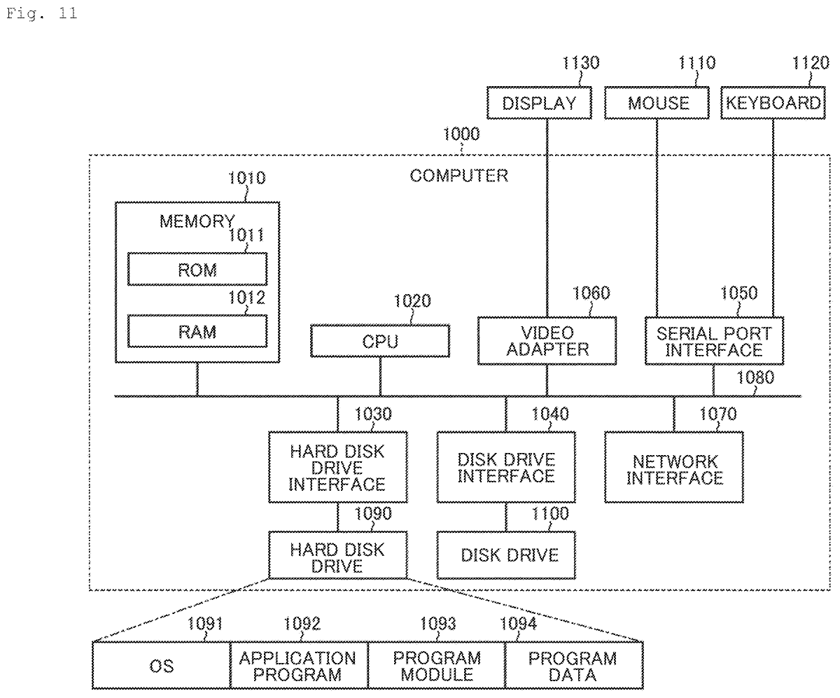

FIG. 11 is a diagram showing an example of a computer that executes a design program. For example, a computer 1000 includes a memory 1010 and a CPU 1020. The computer 1000 also includes a hard disk drive interface 1030, a disk drive interface 1040, a serial port interface 1050, a video adapter 1060, and a network interface 1070. Each of these units is connected by a bus 1080.

The memory 1010 includes a ROM (Read Only Memory) 1011 and a RAM (Random Access Memory) 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. In other words, a program defining each processing step of the design apparatus 10 is implemented as the program module 1093 which describes a code that can be executed by a computer. The program module 1093 is stored in, for example, the hard disk drive 1090. For example, the program module 1093 for executing similar processing as the functional components in the design apparatus 10 is stored in the hard disk drive 1090. Note that the hard disk drive 1090 may be replaced with an SSD (Solid State Drive).

In addition, setting data to be used in processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the embodiment described above.

The program module 1093 or the program data 1094 is not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (a LAN (Local Area Network), a WAN (Wide Area Network), or the like). In addition, the program module 1093 and program data 1094 may be read out from the other computer via the network interface 1070 by the CPU 1020.

### REFERENCE SIGNS LIST

N Communication network
1 Communication system
10 Design apparatus
11 Interface unit
12 Storage unit
13 Control unit
20 Monitoring apparatus
30 Control apparatus
121 Route DB
122 Topology DB
123 Traffic DB
131 Shortest route calculating unit
132 Optimizing unit
133 Approximation calculating unit
134 Mapping unit

1. A design apparatus, comprising:
an optimizing unit, implemented using one or more computing devices, configured to optimize, with a first granularity, a traffic volume allocated to each of links between adjacent nodes included in a network; and
an approximation calculating unit, implemented using one or more computing devices, configured to calculate an approximation solution obtained by approximating, with a second granularity, the traffic volume that is optimized with the first granularity.

2. The design apparatus according to claim 1, wherein:
the optimizing unit is configured to optimize a traffic matrix with a real number solution, and
the approximation calculating unit is configured to approximate the real number solution with an integer solution.

3. The design apparatus according to claim 1, further comprising a mapping unit, implemented using one or more computing devices, configured to map logical paths to each of routes constituted by the links in accordance with the approximated traffic volume.

4. The design apparatus according to claim 3, wherein the mapping unit is configured to prioritize mapping to a route of which the approximated traffic volume is less than a predetermined threshold, and, based on the approximated traffic volume not being sufficient, perform mapping by prioritizing a route of which the approximated traffic volume is largest.

5. A design method executed by a design apparatus, the design method comprising:
optimizing, with a first granularity, a traffic volume allocated to each of links between adjacent nodes included in a network; and
calculating an approximation solution obtained by approximating, with a second granularity, the traffic volume that is optimized with the first granularity.

6. A non-transitory recording medium storing a design program, wherein execution of the design program causes a computer to perform operations comprising:
optimizing, with a first granularity, a traffic volume allocated to each of links between adjacent nodes included in a network; and
calculating an approximation solution obtained by approximating, with a second granularity, the traffic volume that is optimized with the first granularity.
